(19) United States
(12) Patent Application Publication
(10) Pub. No.: US 2013/0067525 A1
(43) Pub. Date: Mar. 14, 2013

(54) SERVICE PROVISIONING DEVICE WITH INTEGRATED CABLE MODEM

(71) Applicant: Jon-En Wang, Chandler, AZ (US)

(72) Inventor: Jon-En Wang, Chandler, AZ (US)

(73) Assignee: PCT International, Inc., Mesa, AZ (US)

(21) Appl. No.: 13/229,493

(22) Filed: Sep. 9, 2011

(51) Int. Cl. H04N 7/173

(52) U.S. Cl. 725/111

(57) ABSTRACT

A cable service provisioning device includes an integrated cable modem to enable a cable provider to send configuration commands. The device includes an input component that receives an input signal from a cable network and an output component that provides an output signal to a customer premises. The device further includes a cable modem configured to receive configuration commands from a cable head end, radio frequency filters configured to selectively pass a portion of the input signal; and a radio frequency switchboard coupled to the input component, the output component, and the one or more radio frequency filters. A processor is coupled to the cable modem and the radio frequency switchboard and is configured to control the radio frequency switchboard to selectively enable or disable individual radio frequency filters in response to the configuration commands received from the cable head end.

### TECHNICAL FIELD

The present invention relates to devices for remotely controlling provisioning of cable services to customer premises.

### BACKGROUND

In recent years, cable networks have become popular as a mechanism for distributing video, audio, telephone, and data services to homes and businesses. These cable networks are commonly implemented as hybrid fiber coaxial (HFC) networks, which use a combination of optical fiber and coaxial cable to distribute radio frequency (RF) signals from a central facility operated by the cable provider to individual customer premises.

Cable providers generally provide multiple service packages that customers may subscribe to. These service packages or levels may include distinct services, such as video, telephone, or data, and different tiers of service, such as different packages of television channels. This creates a problem for cable providers because it is very expensive to set up a new customer or to change the services provided to a customer. In current cable systems, a cable provider must send a technician to customer premises to enable service or change the level of service for that customer. Some cable systems attempt to reduce this expense using addressable multi-taps. In general, multi-tap components are used to distribute the cable signal from a cable trunk line to individual customer premises. Addressable multi-taps allow the cable provider to send a signal from a central location to the multi-tap component to enable or disable specific taps to individual customer premises.

However, this solution suffers from several limitations. In particular, addressable multi-tap components require a separate signaling infrastructure that must be installed throughout the cable system, including at the cable network's head end. In addition, addressable multi-tap components only provide the ability to enable or disable service to a particular customer. Cable providers must still send technicians to change the level of service provided to a customer.

### BRIEF DESCRIPTION OF THE DRAWINGS

FIG. 1 is a diagram of a representative environment in which the service provisioning device operates.

FIG. 2 illustrates a representative environment for distributing a cable signal within the customer premises.

FIG. 3 is a block diagram of an embodiment of the service provisioning device.

FIG. 4 is a block diagram of an alternate embodiment of the service provisioning device.

FIG. 5 is a flowchart of a process for configuring the service provisioning device.

### DETAILED DESCRIPTION

Various embodiments of cable service provisioning devices having an integrated cable modem are disclosed. The service provisioning device receives a signal from a cable provider and provides some portion of the signal to a customer premises based on the level of services that the customer has subscribed to. The cable modem provides a data connection with a head end component of a cable network so that the cable provider can send configuration commands to the service provisioning device. The service provisioning device can then change the services provided to the customer premises in response to the configuration commands.

In some embodiments, the servicing provisioning device includes an input port, which receives an input signal from a cable network. A signal splitter provides a portion of the signal to the cable modem, which initially provisions a data connection with a head end component of the cable network. During operation, the cable modem receives configuration commands from the head end component and provides them to a central processing unit (CPU) board, which re-configures the device in response. The CPU board changes the configuration of a filtering component, such as an RF switchboard, to pass or block particular portions of the input cable signal. In one embodiment, the CPU board enables or disables switches on the RF switchboard to enable a specified set of RF filters to pass the desired parts of the input signal. Each RF filter is configured to pass a frequency band corresponding to services offered by the cable provider, such as particular classes of service (e.g., telephone, data, etc.) or group of channels (e.g., for premium channel packages). In some cases, the configuration command may direct the CPU board to entirely shut off the customer's access to the cable signal by blocking the entire input signal. In other cases, the configuration command may direct the CPU board to turn particular filters on or off.

The service provisioning device can also include an output port that provides the output signal of the RF filters to the customer premises. Once the signal is inside the customer premises, it may be distributed according to well-known methods. The service provisioning device may also include a power extractor which can receive power from the customer premises through the output port of the service provisioning device.

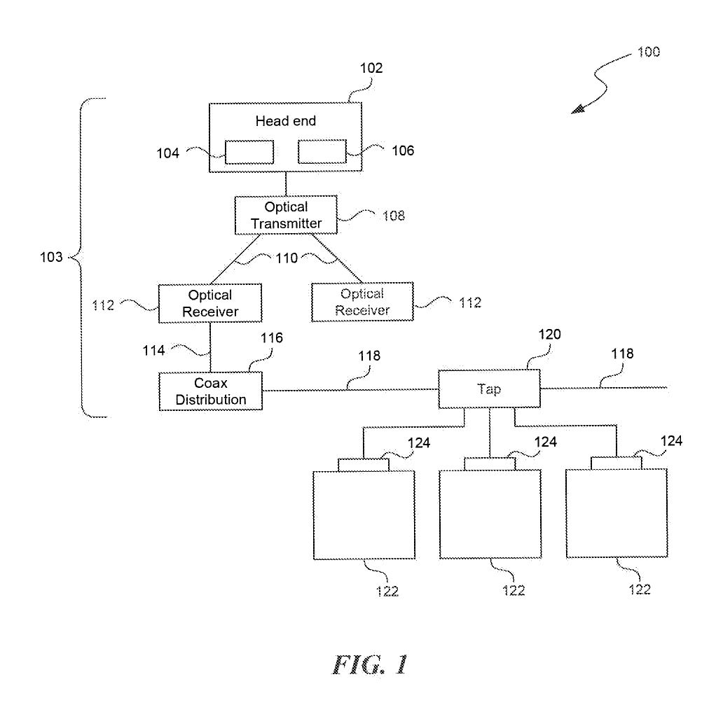

FIG. 1 is a diagram of a representative environment 100 in which the service provisioning device operates. The representative environment 100 depicts an HFC network 103 that transmits a cable signal using a combination of optical fiber and coaxial cable. In general, the HFC network 103 uses optical fiber for long-distance transmissions and coaxial cable for transmissions over shorter distances. However, the service provisioning device is not limited to operating in HFC networks and may operate in any network having similar infrastructure, such as an all-coaxial cable network.

The environment 100 includes a cable head end component 102, which generates data streams to be transmitted over the HFC network 103. These data streams correspond to the various services provided by the cable provider, including video and audio programming, telephony, and data communications. The head end component 102 includes various sub-components to handle these data streams. For example, the head end component 102 includes a modulator 104, which receives video streams for television channels to be broadcast and modulates those video streams for transmission over the cable network. The head end component 102 also includes a cable modem terminating system (CMTS) 106, which manages communications and connectivity for cable modems that are deployed throughout the HFC network 103. In particular, the CMTS 106 allocates an Internet Protocol (IP) address to each authorized cable modem and passes data between each cable modem and the Internet. The CMTS 106 may also support Voice over Internet Protocol (VOIP) services provided to customer premises.

The environment 100 also includes an optical transmitter 108, which is associated with the head end component 102. The optical transmitter 108 combines the signals from the modulator 104 and the CMTS 106 into a cable signal, which it transmits over fiber optic lines 110. The cable signal is then received by optical receivers 112 and 113 at the other end of the fiber optic lines 110.

The optical receivers 112 and 113 convert the cable signal into an equivalent electrical signal for transmission over coaxial lines for distribution to local destinations. The optical receiver 112 then transmits the electrical signals over the coaxial plant trunk line 114. The optical receiver 113 also transmits electrical signals over additional trunk lines (not shown). The coaxial plant trunk line 114 is connected to one or more coaxial distribution components 116, which are used to distribute the cable signal at the neighborhood level. Although not shown in FIG. 1, coaxial distribution component 116 also includes an output trunk line for transmitting the cable signal to another coaxial distribution component. The coax distribution component 116 also connects to a feeder line 118, which distributes the cable signal to the local neighborhood. The feeder line 118 is connected to one or more multi-taps 120, which distribute the cable signal to the customer premises. As used herein, a “multi-tap” is an electrical component that extracts a portion of the cable signal received from the feeder line 118 and distributes it to an individual customer premises. Only a small portion of the signal power goes to the individual customer premises; most of the signal power on the feeder line 118 passes through the multi-tap 120 to a second feeder line 122.

The multi-tap 120 provides the cable signal to each of the customer premises 124 through tap lines 126. Each tap line 126 connects to a service provisioning device 128, which is associated with an individual customer premises 124. As discussed in detail below, the service provisioning device 128 is designed to deliver a portion of the cable signal to the customer premises based on the services that the customer is subscribed to. For example, a service provisioning device 128 may be configured to provide only basic cable TV channels to the customer premises 124 for one customer. For another customer, a service provisioning device 128 may be configured to provide basic channels, premium channels, and data communications to the customer premises 124. The design of the service provisioning device 128 is discussed in greater detail below.

For simplicity, FIG. 1 shows only a portion of a complete HFC network. One skilled in the art will appreciate that an operational HFC network will generally include many optical receivers 112, coaxial distribution components 116, and multi-taps 120.

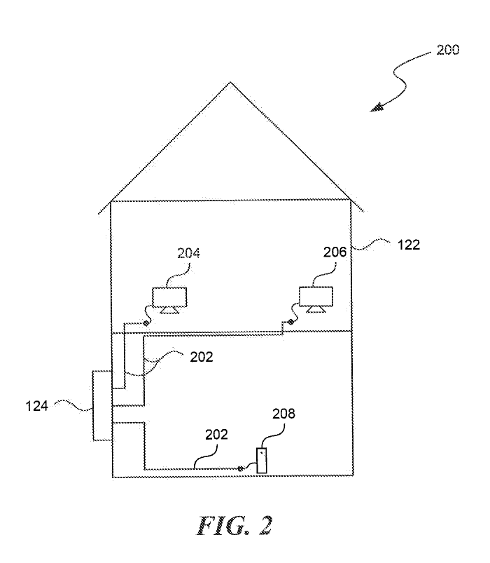

FIG. 2 illustrates a representative environment 200 for distributing a cable signal within the customer premises 124. Although the customer premises 124 is depicted in FIG. 2 as a house, the customer premises 124 may also be an apartment building, an office building, or any other type of facility. In some embodiments, the service provisioning device 128 is mounted to the exterior of the customer premises 124. In other embodiments, the service provisioning device 128 may be buried underground or deployed as a free-standing device. In some embodiments, the service provisioning device 128 includes a weatherproof enclosure to protect the internal components from elements such as ice, snow, and rain.

As discussed above, the cable signal is received by a service provisioning device 128, which outputs a portion of the cable signal corresponding to the customer's service plan. This output signal is then provided to a splitter 201, or similar distribution component, which splits the signal into multiple paths for transmission to different parts of the customer premises 124. The splitter 201 is connected to one or more internal coaxial cable lines 202, each of which is connected to a different room of the customer premises 124. Individual devices, such as televisions 204 and 206 or cable modem 208, are then connected to the distribution lines 202.

Although not shown in FIGS. 1 and 2, the overall system may also include one or more amplifiers to counter signal losses in the distribution network. For example, the environment 100 of FIG. 1 may include trunk amplifiers, line amplifiers, and/or bridge amplifiers connected to components of the cable network 103. Similarly, the environment 200 of FIG. 2 may also include in-house amplifiers to boost the signal for distribution to different parts of the customer premises 124.

In general, the cable provider must configure its network to provide the correct signal to each customer. Typically, when a customer subscribes to a particular class of service from the cable provider, the cable provider must configure a set of RF filters (e.g., within a multi-tap) to selectively pass parts of the cable signal to the customer premises 124. To add a new customer, the provider configures the network to begin providing the cable signal to the customer premises 124. Similarly, when the customer terminates service, the service provider must reconfigure components in the network to stop providing the cable signal to the customer premises 124. In between, if a customer changes the level of service, the cable provider must reconfigure the network to ensure that the customer premises 124 receives the services that are being paid for.

In current systems, this can be a very complicated and labor-intensive task. Often, setting up service, terminating service, or changing level of service requires that the cable provider send a technician to swap RF filters or otherwise enable or disable service at the service provisioning device or the multi-tap. Because this process is so labor intensive, it is extremely costly for the cable provider and imposes significant overhead, requiring that the cable provider retain the customer for a significant period of time before the customer becomes profitable.

One attempt to address this problem is through the use of addressable multi-taps. Conventional addressable multi-taps provide a communications channel through which the cable provider may send a signal to the multi-tap to enable or disable particular taps. However, these systems have several limitations. First, current addressable multi-taps are only capable of turning service on and off for a particular customer premises. They are not capable of modifying the signal that will be received by the customer premises based on different levels of service. Moreover, current addressable multi-taps require special equipment at the head end component 102 to send commands to the addressable multi-tap. This requirement adds significant cost to the cable provider.

In order to address this problem, the service provisioning device 128 disclosed herein includes an integrated cable modem that communicates with and receives commands from the head end component 102. Based on these commands, the service provisioning device 128 can enable service, disable service, or modify the level of service being provided to the customer premises 124.

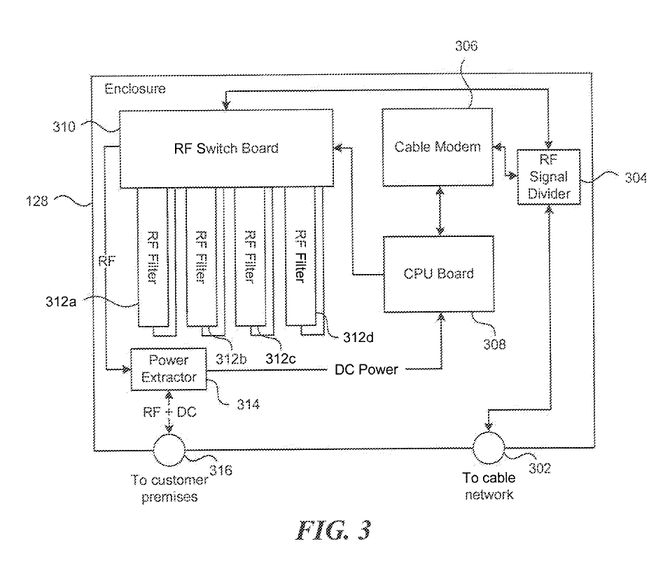

FIG. 3 is a block diagram of an embodiment of the service provisioning device 128. The service provisioning device 128 includes an input port 302, which connects to one of the tap lines 126 (FIG. 1) and receives a cable signal from the head end component 102. One skilled in the art will appreciate that the input port may be any type of coaxial connector known in the art, such as an F connector. The cable signal is provided to an RF signal divider 304, which splits the signal into two components. A first component of the cable signal is provided to a cable modem 306 and a second component of the cable signal is provided to an RF switchboard 310. The RF signal divider 304 may be implemented using any known technique for separating a signal into signal paths. For example, the RF signal divider 304 may be implemented as a splitter, which generates several signals of approximately equal power. Alternatively, the RF signal divider 304 may be a tap, which provides a small portion of the signal power to one output while providing the remainder of the signal power to a main output path.

The cable modem 306 receives the component of the cable signal used for data communications with the head end component 102. The cable modem 306 is implemented according to techniques well known in the art, and may communicate with the CMTS 106 according to industry standards, such as Data Over Cable Service Interface Specification (DOCSIS) versions 1.0, 2.0, or 3.0. Such standards enable the cable modem 306 to exchange data and commands with the CMTS over the cable network 103 using well-known protocols, such as Transport Control Protocol/Internet Protocol (TCP/IP). During operation, the head end component 102 uses the cable modem connection to send configuration commands to the service provisioning device 124.

The cable modem 306 is coupled to a CPU board 308, which receives the commands from the cable modem 306 and controls the service provisioning device 128 in response to the commands. In some embodiments, the CPU board 308 includes an embedded processor running an embedded operating system (OS). The embedded OS may be a commercial embedded OS, such as VxWorks, sold by Wind River Systems of Alameda, Calif., or a freely available embedded operating system, such as an embedded form of the Linux operating system. The CPU board 308 may also be, or may include, one or more programmable general-purpose or special-purpose microprocessors, digital signal processors (DSPs), programmable controllers, application specific integrated circuits (ASICs), programmable logic devices (PLDs), or the like, or a combination of such devices. Assuming a programmable implementation, the code to support the functionality of the CPU board 308 may be stored on a computer-readable medium such as an optical drive, flash memory, or a hard drive. Depending on the hardware implementation, at least some of these functions may be implemented by hardware, software, and/or firmware.

The CPU board 308 provides support for direct communications with components located at the head end component 102. In some embodiments, the CPU board 308 implements a web server, which is configured to display one or more configuration web pages to a remote location. In these embodiments, a technician at the head end component 102 may use a standard web browser to access the web pages provided by the CPU board 308. The technician may then send commands to the CPU board 308 by selecting options on the displayed web page. These commands are then sent through the cable network 103 using the protocols implemented by the cable modem 306. In some embodiments, the CPU board 308 requires that the operator enter a user name and password to prevent unauthorized access.

The CPU board 308 may also support other interfaces for device management. For example, the CPU board 308 may provide a command line interface that may be accessed through a secure shell (SSH) or other remote connection utility. The CPU board 308 may also support standard network management methods, such as Simple Network Management Protocol (SNMP), which is defined in various Requests for Comments (RFCs) maintained by the Internet Engineering Task Force (IETF). In the case of SNMP, the CPU board 308 may use SNMP community settings to restrict unauthorized access. In some embodiments, the configuration commands themselves may also be encrypted.

Regardless of the implementation of the interface to the CPU board 308, the use of the cable modem 306 and the CPU board 308 enables a technician at the head end component 102 to send configuration commands to the service provisioning device 128. These configuration commands may direct the service provisioning device 128 to enable or disable access to particular groups of channels, particular services, or to the entire signal. In this last case, the communication enables a technician at the head end to turn on or turn off service for a particular customer.

The service provisioning device 128 also includes a radio frequency switchboard 310, which is connected to one or more RF filters 312a-312d. Although FIG. 3 shows four separate RF filters, the service provisioning device 128 may include any number of RF filters depending on the needs of the cable provider. Moreover, as used herein, “filter” may refer to any component that can be used with the RF switchboard to pass or block all or part of the input signal. These may include, for example, pass-through components that pass all frequencies and terminators that block all frequencies. The RF switchboard 310 is coupled to the CPU board 308, so that the CPU board 308 can control the configuration of the RF switchboard 310 to enable or disable particular RF filters 312a-312d in response to configuration commands from the head end component 102.

The RF switchboard 310 is also coupled to the RF signal divider 304 so that it receives at least a portion of the cable signal. Generally, the RF switchboard 310 includes an array of switches that can be set to enable or disable individual RF filters 312a-312d. The cable signal from the RF signal divider 304 is passed through all of the enabled RF filters 312a-312d. Each RF filter 312a-312d is associated with a particular set of channels or a particular class of service. As such, each RF filter 312a-312d is configured to pass a specific range of frequencies and to block the remaining set of frequencies. When there is only one filter, the RF switchboard 310 simply provides an on/off control for access to the cable signal. When there is more than one filter, the RF switchboard 310 provides more fine-grained control over the services that are passed through. The cable signal is simultaneously passed through each of the enabled RF filters 312a-312d and combined afterwards, so that the output signal from the RF switchboard 310 includes only the bands associated with the services that should be provided to the customer premises. In one embodiment, the RF switchboard 310 is coupled to the RF filters 312a-312d through one or more radio frequency coaxial connectors.

As shown in FIG. 3, the RF switchboard 310 generates an output signal that is provided to a power extractor component 314. The power extractor 314 passes the output signal from the RF switchboard 310 to an output port 316. As with the input port 302, the output port 316 may be any type of coaxial connector known in the art, such as an F connector. From the output port 316, the signal may then be distributed throughout the customer premises as described in FIG. 2.

In some embodiments, the power extractor component 314 is used to receive power for the service provisioning device 128 from the customer premises. In these embodiments, the service provisioning device 128 is connected to the customer premises such that the service provisioning device receives power over the coaxial cable connected to the output port 316. The power extractor 314 extracts the power from the combined signal on the coaxial cable and uses the power to operate the CPU board 308, the cable modem 306, and the RF switchboard 310. In other embodiments, the service provisioning device 128 instead includes a separate power cable that is connected directly to a power source, such as an electrical outlet in the customer premises 124.

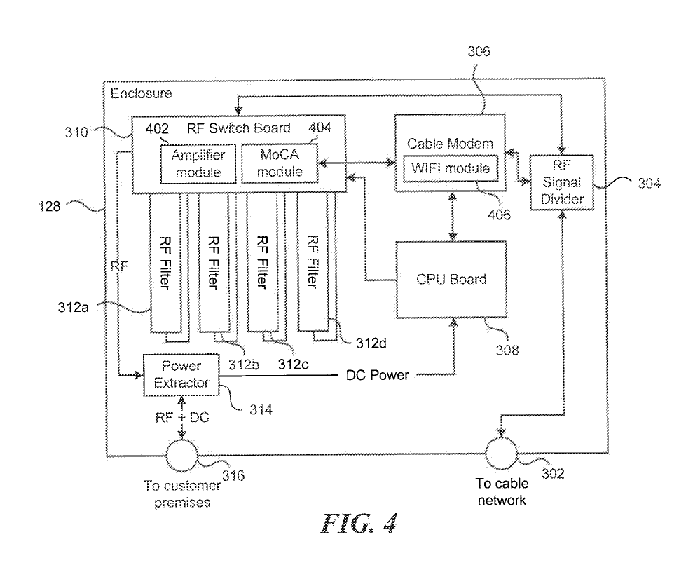

FIG. 4 is a block diagram of an alternate embodiment of the service provisioning device 128. This alternate embodiment performs in a similar manner to the embodiment discussed above with reference to FIG. 3. However, the embodiment of FIG. 4 also includes various value-added features to enhance the services provided to the customer premises 124. In general, components present in both FIGS. 3 and 4 operate similarly; thus, the embodiment of FIG. 4 includes a cable modem 306, a CPU board 308, an RF switchboard 310, and RF filters 312a-312d, which operate generally as discussed above.

In addition, the service provisioning device 128 of FIG. 4 includes an amplifier module 402, which amplifies the signal provided to the customer if the customer is currently receiving a weak signal. This may occur, for example, when the customer premises 124 is distant from the nearest coaxial distribution components 116 or if the line is poor quality. During operation, the amplifier module 402 may amplify the input signal from the RF signal divider 304 or the output signal before it is provided to the power extractor 314. The amplifier module 402 may also amplify outbound signals transmitted from the customer premises to the head end component 102. The amplifier module 402 may be, for example, a wide bandwidth amplifier that is designed amplify the entire cable signal. Alternatively, the amplifier module 402 may be an equalizer or other component used to balance an uneven signal response in the transmission lines. For example, the amplifier module 402 may be designed to amplify a frequency band that suffers particularly high attenuation during transmission, while providing less or no amplification to other frequency bands of the cable signal.

The embodiment of FIG. 4 also includes customer-facing components that allow the customer premises 124 to also use the cable modem 306. This may be more efficient for both the cable provider and the customer. The customer benefits by not having to buy or rent a separate cable modem, while the cable provider reduces the number of cable modem connections that it has to provision. To support this functionality, the embodiment of FIG. 4 includes a multimedia over coax (MoCA) module 404 and a wireless transceiver 406. MoCA is a standard that uses coaxial cable to transmit local area network (LAN) data. The MoCA module 404 acts as a data hub, similar to an ethernet switch, for enabling a LAN within the customer premises 124. The service provisioning device 128 may also include a wireless transceiver 406, which provides a wireless local area network (WLAN) for use within the customer premises 124. The wireless transceiver 406 may implement any suitable wireless network protocol, such as the IEEE 802.11a, 802.11b, 802.11g, or 802.11n standards.

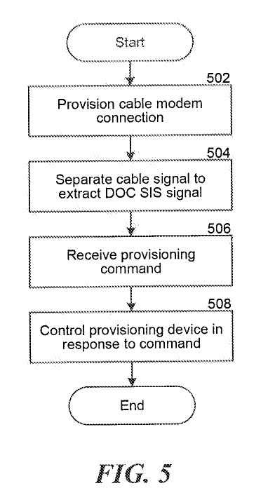

FIG. 5 is a flowchart of a process 500 for configuring the service provisioning device 128. Processing begins at block 502, where the cable modem 306 establishes a data connection with the head end component 102 (FIG. 1). In this step, the cable modem 306 communicates with the CMTS 106 according to standard protocols to request an IP address and any other needed network resources. The cable provider may use a unique medium access control (MAC) address assigned to the cable modem 306 to identify the service provisioning device 128 (and the corresponding customer). The cable provider then uses the established connection to send configuration commands to the service provisioning device 128 to enable or disable services to the customer.

Processing then proceeds to block 504, where the service provisioning device 128 separates the cable signal to extract the cable modem portion of the signal. In block 506, the service provisioning device 128 receives a configuration command from the head end component 102 via the cable modem 306. Generally, the configuration command specifies particular frequency bands that should be passed or blocked or particular filters that should be enabled or disabled. As discussed above, the cable modem 306 may receive the configuration command through a variety of methods, including through a web page provided by an embedded web server in the CPU board 308. The configuration command may also be provided through SNMP or through the other network communication methods discussed above. Processing then proceeds to block 508, where the CPU board 308 re-configures the service provisioning device 128 based on the configuration command by specifying which parts of the cable signal should be passed or blocked. As discussed above, this may be done by controlling switches on the RF switchboard 310 to enable particular RF filters 312a-312d to pass or block the appropriate part of the signal.

Processing then returns to block 506, where the service provisioning device waits for and responds to the next configuration command from the head end component 102. Generally, this monitoring continues as long as the service provisioning device is operating, so that the cable provider will always be able to change the level of service.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A cable service provisioning device comprising:
an input component configured to receive an input signal from a cable network;
an output component configured to provide an output signal to a premises;
a cable modem configured to receive configuration commands from a cable head end;
one or more radio frequency filters, each radio frequency filter configured to selectively pass or block a portion of the input signal;
a radio frequency switchboard coupled to the input component, the output component, and the one or more radio frequency filters; and
a processor coupled to the cable modem and the radio frequency switchboard and configured to control the radio frequency switchboard to selectively enable or disable individual radio frequency filters of the one or more radio frequency filters in response to the configuration commands received from the cable head end.

2. The service provisioning device of claim 1, wherein individual radio frequency filters of the one or more radio frequency filters correspond to groups of television channels provided in the input signal.

3. The service provisioning device of claim 1, further comprising a power extractor coupled to the output component and configured to receive power from a power supply located at the customer premises.

4. The service provisioning device of claim 1, further comprising a radio frequency signal divider coupled to the input component and configured to divide the input signal into a first portion to be provided to the cable modem and a second portion to be provided to the radio frequency switchboard.

5. The service provisioning device of claim 1, further comprising a weather resistant enclosure at least partially containing the input component, the output component, the cable modem, the one or more frequency filters, the radio frequency switchboard, and the processor.

6. The service provisioning device of claim 1, wherein the radio frequency switchboard is coupled to the one or more radio frequency filters through one or more radio frequency coaxial connectors.

7. The service provisioning device of claim 1, further comprising one or more amplifier modules coupled to the input component and configured to amplify at least a portion of the input signal.

8. The service provisioning device of claim 1, further comprising a network component coupled to the cable modem and configured to provide network connectivity from a computing device at the customer premises through the cable modem.

9. The service provisioning device of claim 8, wherein the network component comprises at least one of a wireless data transceiver or a multimedia over coax (MoCA) module.

10. The service provisioning device of claim 1, wherein the cable network is a Hybrid Fiber Coaxial (HFC) network.

11. A method for controlling a cable service provisioning device, the method comprising:
receiving a cable signal from a cable head end;
separating the received cable signal into a data communications portion and a non-data communications portion;
providing the data communications portion of the received cable signal to a cable modem in the cable service provisioning device;
receiving at the cable modem a service configuration command from the cable head end; and
in response receiving the service configuration command, configuring the service provisioning device to block the received signal or to produce an output signal by selectively passing at least a part of the received cable signal.

12. The method of claim 11, wherein configuring the service provisioning device to generate an output signal comprises selectively enabling one or more radio frequency filters, each radio frequency filter configured to pass a portion of the received cable signal.

13. The method of claim 11, further comprising amplifying at least a portion of the input signal before producing the output signal.

14. The method of claim 11, further comprising providing network connectivity through the cable modem to a computing device at the customer premises.

15. The method of claim 14, wherein providing network connectivity comprises providing at least one of a wireless data network or a multimedia over coax (MoCA) network.

16. A cable system comprising:
a cable head end configured to transmit a cable signal having a data communications portion and a non-data communications portion;
a cable distribution network; and
a service provisioning device comprising:
input means for receiving the cable signal from the cable head end;
output means for providing an output signal based on the input signal;
a cable modem configured to receive configuration commands from the cable head end;
a filtering component coupled between the input means and the output means and configured to selectively pass or block portions of the input signal;
means for controlling the filtering component to selectively pass or block portions of the input signal in response to the configuration commands received from the cable head end.

17. The cable system of claim 16, wherein the service provisioning device further comprises a power extractor coupled to the output component and configured to receive power from a power supply located at the customer premises.

18. The cable system of claim 16, wherein the service provisioning device further comprises a radio frequency signal divider coupled to the input component and configured to divide the input signal into a first portion to be provided to the cable modem and a second portion to be provided to the filtering component.

19. The cable system of claim 16, wherein the service provisioning device further comprises a weather-resistant enclosure at least partially containing the input component, the output component, the cable modem, the filtering component, and the processor.

20. The cable system of claim 16, wherein the filtering component comprises a switchboard and a plurality of filters, each filter configured to pass a particular frequency band.

21. The cable system of claim 16, wherein the service provisioning device further comprises one or more amplifier modules coupled to the input component and configured to amplify at least a portion of the input signal.

22. The cable system of claim 16, wherein the service provisioning device further comprises a network component coupled to the cable modem and configured to provide network connectivity from a computing device at the customer premises through the cable modem.

23. The cable system of claim 22, wherein the network component comprises at least one of a wireless data transceiver or a multimedia over coax (MoCA) module.

24. The cable system of claim 16, wherein the cable distribution network is a Hybrid Fiber Coaxial (HFC) network.

25. A cable service provisioning device comprising:
input means for receiving the cable signal from a cable head end;
output means for providing an output signal based on the input signal;
a cable modem configured to receive configuration commands from the cable head end;
a filtering component coupled between the input means and the output means and configured to selectively pass or block portions of the input signal; and
a processor coupled to the cable modem and the filtering component and configured to control the filtering component to selectively pass or block portions of the input signal in response to the configuration commands received from the cable head end.

26. The cable service provisioning device of claim 25, wherein the service provisioning device further comprises a radio frequency signal divider coupled to the input component and configured to divide the input signal into a first portion to be provided to the cable modem and a second portion to be provided to the filtering component.

27. The cable service provisioning device of claim 25, wherein the filtering component comprises a switchboard and a plurality of filters, each filter configured to pass or block a particular frequency band.

28. The cable service provisioning device of claim 25, wherein the service provisioning device further comprises a network component coupled to the cable modem and configured to provide network connectivity from a computing device at the customer premises through the cable modem.

29. The cable service provisioning device of claim 28, wherein the network component comprises at least one of a wireless data transceiver or a multimedia over coax (MoCA) module.
